(19) United States
(12) Patent Application Publication
(10) Pub. No.: US 2011/0292095 A1
(43) Pub. Date: Dec. 1, 2011

(54) DISPLAY DEVICE

(75) Inventors: Hidefumi Yoshida, Osaka (JP); Susumu Okazaki, Osaka (JP)

(73) Assignee: Sharp Kabushiki Kaisha

(21) Appl. No.: 13/147,786

(22) PCT Filed: Feb. 3, 2010
(86) PCT No.: PCT/JP2010/000641

§ 371 Date: Aug. 3, 2011

(30) Foreign Application Priority Data
Feb. 4, 2009 (JP) 2009 023949

(51) Int. Cl. G09G 3/36; G09G 5/10

(52) U.S. Cl. 345/690; 345/87

(57) ABSTRACT

In order to provide a display device including a liquid crystal display element and a light-emitting display element that are controlled so as to be individually driven, a display device (1) of the present invention includes a glass substrate (11), a glass substrate (31) facing the glass substrate (11), a pixel electrode (40) which is provided between the glass substrates (11) and (31) and which also serves as a light reflecting layer, a reflective liquid crystal display element (85) including a liquid crystal layer (20), an organic EL display element (86) which includes an organic EL material layer (52) provided between the glass substrate (31) and the pixel electrode (40) and which perform display operation by employing light emitted from the organic EL material layer (52), a TFT (36) which is provided between the glass substrates (11) and (31) and which controls driving of the liquid crystal display element (85), and a TFT (37) which is provided between the glass substrates (11) and (31) and which controls driving of the organic EL display element (86).

### TECHNICAL FIELD

The present invention relates to a display device that carries out liquid crystal display and light-emitting display.

### BACKGROUND ART

In a technical field of display devices, an organic EL (Electro Luminescence) display has drawn attention because of its excellent display quality. The organic EL display shows a greatly excellent contrast ratio indoors or in a darkroom, and carries out display with wider dynamic range.

However, the organic EL display shows an extremely poor visibility outdoors. Generally, the organic EL display is provided with a metal electrode. Therefore, external light that enters the organic EL display is reflected on the metal electrode. This causes excessive deterioration in display contrast. This is one of the reasons why the organic EL display shows the extremely poor visibility outdoors.

In order to prevent the metal electrode from reflecting external light, for example, 1) a circularly polarizing plate is attached to a display surface of the organic EL display (referred to as “conventional arrangement 1”), or 2) an interference film (microcavity) is provided in the organic EL display (referred to as “conventional arrangement 2”).

Further, there has been proposed a display device serving as both the organic EL display and the liquid crystal display (referred to as “conventional arrangement 3”; see Patent Literature 1). In a case where external light is relatively strong outdoors or the like, the display device functions as the liquid crystal display. Specifically, according to the conventional arrangement 3, the organic EL display and the reflective liquid crystal display perform display operation on an identical display screen. The organic EL display and the reflective liquid crystal display are driven by shared TFTs (Thin Film Transistors). Specifically, according to the conventional arrangement 3, first TFTs that control whether to supply a data signal from a source line “control whether to apply a voltage to a liquid crystal layer”, and “a data voltage applied in a case where the first TFTs are activated” “controls whether to activate second TFTs for driving an organic EL layer”.

### CITATION LIST

Patent Literature

Patent Literature 1

Japanese Patent Application Publication Tokukai No. 2003-76302 A (Publication Date: Mar. 14, 2003)

### SUMMARY OF INVENTION

### Technical Problem

However, the conventional arrangement 1 causes reduction in quantity of light emitted from an organic EL display due to a circularly polarizing plate. This leads to deterioration in display luminance of the organic EL display. Further, the conventional arrangement 2 does not sufficiently yield an effect of preventing a metal electrode from reflecting external light. It is therefore still difficult to use the organic EL display outdoors.

The conventional arrangement 3 does not cause the problems caused by the conventional arrangements 1 and 2. However, the conventional arrangement 3 should meet the following requirements 1) and 2). Therefore, an arrangement simpler than the conventional arrangement 3 is possibly requested.

1) In a case where a display device of the conventional arrangement 3 functions as an organic EL display, a data signal supplied to TFTs is constantly positive. Meanwhile, in a case where the display device of the conventional arrangement 3 functions as a liquid crystal display, the data signal should be alternating via a common potential. That is, the display device of the conventional arrangement 3 should meet requirements of a liquid crystal display mode and an organic EL display mode, the requirements being contradictory to each other.
2) The display device of the conventional arrangement 3 should have TFTs having two different threshold voltages. Specifically, one of the two different threshold voltages should be determined such that only one of the organic EL display and the liquid crystal display is driven, and the other of the two different threshold voltages should be determined such that only the other of the organic EL display and the liquid crystal display is driven. Further, the threshold voltages cannot be extremely great.

The present invention was made in view of the problems, and a main object of the present invention is to provide a display device including a liquid crystal display element and a light-emitting display element that are controlled so as to be individually driven.

### Solution to Problem

In order to attain the object, a display device of the present invention includes: a first substrate; a second substrate facing the first substrate; a light reflecting layer provided between the first substrate and the second substrate; a reflective liquid crystal display element including a liquid crystal layer provided between the first substrate and the light reflecting layer; a light-emitting display element including a light-emitting layer provided between the second substrate and the light reflecting layer; a first switching element for controlling driving of the liquid crystal display element; and a second switching element for controlling driving of the light-emitting display element.

According to the above arrangement, the driving of the liquid crystal display element and the driving of the light-emitting display element are individually controlled by the different switching elements. This makes it possible to thoroughly individually control the driving of the liquid crystal display element and the driving of the light-emitting display element. It is therefore possible to, for example, thoroughly selectively drive either the liquid crystal display element or the light-emitting display element. It is also possible to simultaneously drive the liquid crystal display element and the light-emitting display element if necessary.

### ADVANTAGEOUS EFFECTS OF INVENTION

The present invention makes it possible to provide a display device including a liquid crystal display element and a light-emitting display element that are controlled so as to be individually driven.

### BRIEF DESCRIPTION OF DRAWINGS

FIG. 1

FIG. 1 is a cross-sectional view schematically showing a display device in accordance with an embodiment of the present invention.

FIG. 2

FIG. 2 is a circuit diagram schematically showing an equivalent circuit of a display device of the present invention.

FIG. 3

FIG. 3 is a cross-sectional view schematically showing a display device in accordance with another embodiment of the present invention.

FIG. 4

FIG. 4 is a circuit diagram schematically showing another equivalent circuit of a display device of the present invention.

### DESCRIPTION OF EMBODIMENTS

### First Embodiment

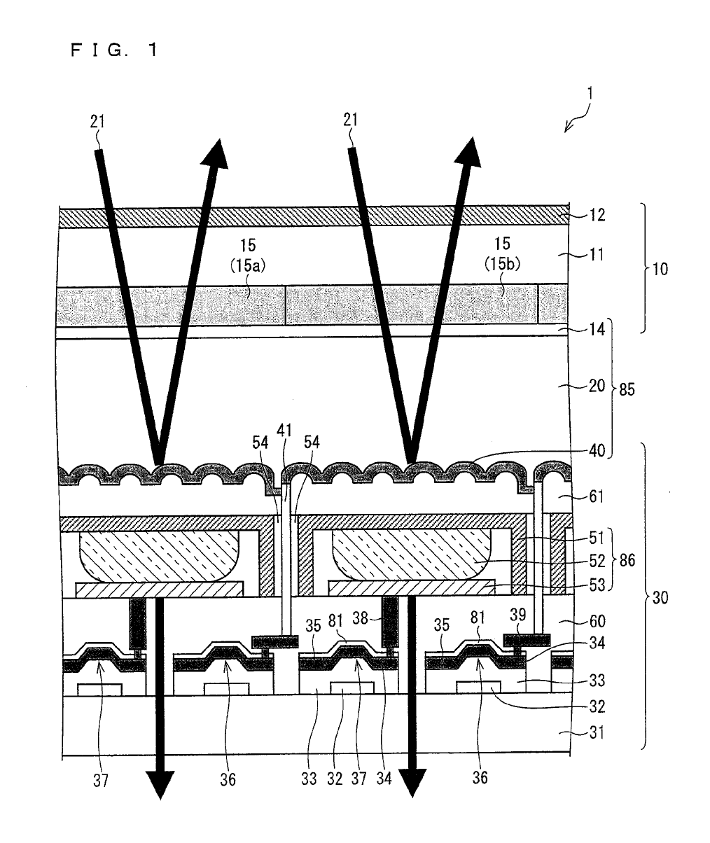

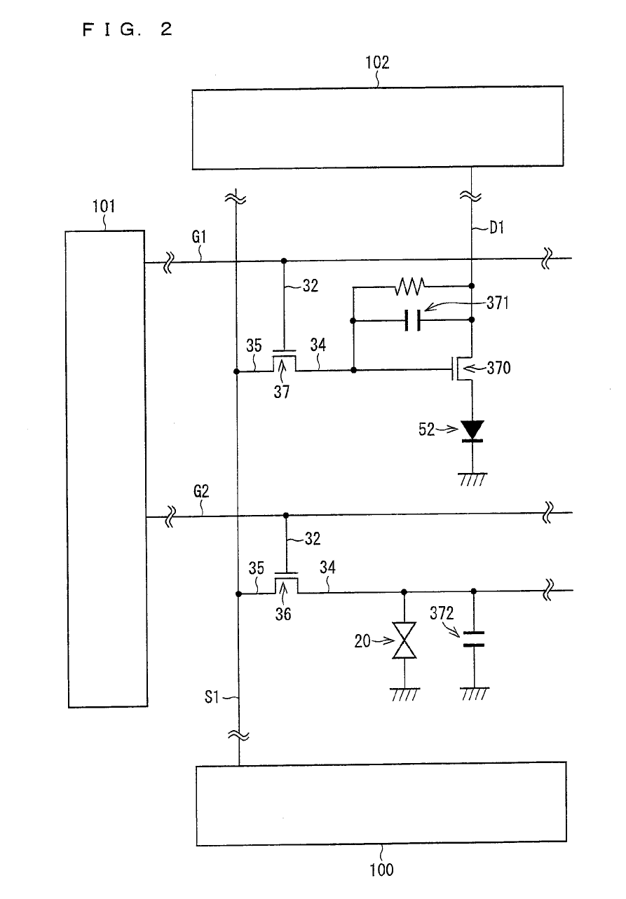

The following describes an embodiment of a display device of the present invention with reference to FIGS. 1 and 2.

(Arrangement of Display Device)

FIG. 1 is a cross-sectional view schematically showing a display device 1 in accordance with the present embodiment. The display device 1 includes a light-transmitting glass substrate 11 (first substrate) and a light-transmitting glass substrate 31 (second substrate) facing each other, pixel electrodes (light reflecting layers) 40 provided between the glass substrates 11 and 31, a liquid crystal layer 20 provided between the glass substrate 11 and the pixel electrodes 40, organic electroluminescence material layers (referred to as “organic EL material layers”; light-emitting layers) 52 provided between the glass substrate 31 and the pixel electrodes 40, and first thin film transistors TFT 36 (first switching elements) and second thin film transistors TFT 37 (second switching elements) that are provided between the glass substrates 11 and 31.

The display device 1 includes, as display elements, reflective liquid crystal display elements 85 and organic EL display elements (light-emitting display elements) 86. Each reflective liquid crystal display element 85 includes the liquid crystal layer 20 and employs, for its display operation, external light 21 that corresponding one of the pixel electrodes 40 reflects. Each organic EL display element (light-emitting display element) 86 includes corresponding one of the organic EL material layers 52 and employs, for its display operation, light emitted from the organic EL material layer 52. Driving of the liquid crystal display element 85 is controlled by corresponding one of the TFTs 36 for driving liquid crystal only, and driving of the organic EL display element 86 is controlled by corresponding one of the TFTs 37 for driving organic EL only. In other words, the TFT 36 is employed for driving the liquid crystal display element 85 but not for driving the organic EL display element 86. Meanwhile, the TFT 37 is employed for driving the organic EL display element 86 only.

That is, the display device 1 is arranged such that the driving of the liquid crystal display element 85 and the driving of the organic EL display element 86 are controlled by different TFTs 36 and 37, respectively. As a result, the display device 1 brings at least the following advantages. Even in a case where the TFTs 36 and 37 are activated/not activated at an identical threshold voltage, the driving of the liquid crystal display element 85 and the driving of the organic EL display element 86 are thoroughly individually controlled. Specifically, either one of the liquid crystal display element 85 and the organic EL display element 86 can be selectively driven, and the liquid crystal display element 85 and the organic EL display element 86 can be simultaneously driven if necessary. Further, TFT designing relating to a threshold voltage or the like can be easier, compared to a case where TFT is shared to drive the liquid crystal display element and the light-emitting display element. According to the display device 1, the TFTs (TFT 37 and TFT 36) drive the light-emitting display element and the liquid crystal display element, respectively. It is therefore possible to easily drive the organic EL display element 86 and the liquid crystal display element 85 that require different types of a data signal to be supplied to the TFTs. The data signal supplied to the light-emitting display element is constantly positive, meanwhile the data signal supplied to the liquid crystal display element is alternating via a common potential.

Further, the display device 1 does not cause deterioration in display luminance of the light-emitting display element though the conventional arrangement 1 causes such deterioration. Furthermore, the display device 1 makes it possible to selectively employ an optimal one of the liquid crystal display element 85 and the organic EL display element 86 in accordance with an intensity of external light. Specifically, in a case where external light is relatively strong outdoors or the like, the display device 1 functions as the reflective liquid crystal display device. Meanwhile, the display device 1 functions as the light-emitting display device such as an organic EL display indoors or the like.

Note that a “liquid crystal display element” of the present invention includes a liquid crystal layer and electrodes for driving the liquid crystal layer, and a “light-emitting display element” of the present invention includes a light-emitting layer and electrodes for driving the light-emitting layer, as described later.

(Detailed Arrangement of Display Device)

The following describes in detail how the display device 1 is arranged with reference to FIGS. 1 and 2. Simply described, the display device 1 includes a color filter substrate (CF substrate) 10, a TFT substrate 30, and the liquid crystal display layer 20 sandwiched between the color filter substrate 10 and the TFT substrate 30.

The color filter substrate 10 includes a glass substrate 11, a polarizer 12 provided on an external surface of the glass substrate 11, a color filter 15 and a counter electrode 14 that is made by a light-transmitting electrode material (ITO: indium tin oxide) provided in this order on an internal surface of the glass substrate 11. Specifically, the internal surface of the glass substrate 11 is a surface of two surfaces of the glass substrate 11 which surface faces the glass substrate 31, and the external surface of the glass substrate 11 is the other surface of the two surfaces of the glass substrate 11.

The TFT substrate 30 includes: the glass substrate 31; and a plurality of TFTs 36 and TFTs 37, an interlayer insulating film 60, the organic EL display elements 86, an interlayer insulating layer 61 and the pixel electrodes 40 provided in this order on an internal surface of the glass substrate 31. Specifically, the internal surface of the glass substrate 31 is one surface of two surfaces of the glass substrate 31 which surface faces the glass substrate 11, meanwhile an external surface of the glass substrate 31 is the other surface of the two surfaces of the glass substrate 31.

Each of the TFTs 36 and the TFTs 37 includes a gate electrode 32, a gate insulating film 33, a drain electrode 34, a source electrode 35 and an electrically-insulating film 81 that are successively laminated in this order on the internal surface of the glass substrate 31.

The organic EL display element 86 is electrically insulated from the TFTs 36 and the TFTs 37 via the interlayer insulating film 60. The organic EL display element 86 includes a first electrode 53, the organic EL material layer 52 and a second electrode 51 that are successively laminated on the interlayer insulating film 60. The first electrode 53 is electrically connected to the drain electrode 34 of the TFT 37 via a connection electrode 38. The second electrode 51 is electrically connected to a variable power supply (not shown). In a case where the display device 1 displays an image or the like by use of the organic EL display element 86, a positive data signal is constantly supplied to the first electrode 53 via the drain electrode 34 of the TFT 37, and then a predetermined voltage in accordance with the data signal is applied to the organic EL material layer 52 sandwiched between the first electrode 53 and the second electrode 51. The organic EL material layer 52 emits light in response to the voltage applied thereon. The first electrode 53 contains a light-transmitting electrode material such as ITO. Meanwhile, the second electrode 51 is a reflective electrode made by a light-reflective electrode material such as aluminum or copper. Accordingly, the light emitted from the organic EL material layer 52 is successively transmitted through the light-transmitting first electrode 53, the light-transmitting interlayer insulating film 60 and the light-transmitting glass substrate 31, and then emitted outside from the glass substrate 31. In this manner, the display device 1 displays the image or the like on the glass substrate 31 by use of the organic EL display element 86. That is, the display device 1 is, what is called, a bottom emission type light-emitting display device that emits light from the glass substrate 31 positioned at the bottom of the display device 1.

The organic EL display element 86 (more specifically, the second electrode 51) is electrically insulated from the pixel electrode 40 via the interlayer insulating film 61. Further, the interlayer insulating film 61 on which the pixel electrode 40 is provided has a finely uneven surface. Therefore, the pixel electrode 40 has an uneven surface identical to that of the surface of the interlayer insulating film 61.

The liquid crystal display element 85 of the display device 1 includes the pixel electrode 40, the counter electrode 14, and the liquid crystal layer 20 sandwiched between the pixel electrode 40 and the counter electrode 14. The pixel electrode 40 is electrically connected to the drain electrode 34 of the TFT 36 via connection electrodes 41 and 39. The counter electrode 14 is electrically connected to a variable power supply (not shown). In a case where the display device 1 displays an image or the like by use of the liquid crystal display element 85, an alternating data signal is supplied to the pixel electrode 40 via the drain electrode 34 of the TFT 36, and then a predetermined voltage in accordance with the data signal is applied to the liquid crystal layer 20 sandwiched between the pixel electrode 40 and the counter electrode 14 whereby the liquid crystal layer 20 is driven. The second electrode 51 is electrically insulated from the connection electrode 41 via an insulating layer 54.

The liquid crystal display element 85 is a reflective display element. Specifically, the external light 21 that enters the display device 1 from the outside of the glass substrate 11 (the polarizer 12) is successively transmitted through the polarizer 12, the glass substrate 11, the color filter 15, the counter electrode 14 and the liquid crystal layer 20, and then diffusely reflected on the uneven surface of the pixel electrode 40. Thereafter, the diffused external light 21 is successively transmitted through the liquid crystal layer 20 driven in accordance with the data signal, the counter electrode 14, the color filter 15, the glass substrate 11 and the polarizer 12, and then emitted outside from the glass substrate 11.

In this manner, the display device 1 displays the image or the like by use of the liquid crystal display element 85 on the glass substrate 11, that is, on a side opposite to a side where the display device 1 displays the image or the like by use of the organic EL display element 86. That is, the display device 1 includes the organic EL display that serving as a main display, and the reflective liquid crystal display which serves as a sub-display and which is formed on the side opposite to the side where the organic EL display is formed, while employing the TFT substrate 30 for the organic EL display and the reflective liquid crystal display.

The reflective liquid crystal display and the organic EL display of the display device 1 can be produced by a method for producing a general reflective liquid crystal display and a method for producing a general organic EL display. Further, the display device 1 includes the color filters 15 and the organic EL material layers 52 each corresponding to R, G or B.

Further, the TFTs 36 and 37 of the display device 1 are formed on an identical substrate (glass substrate 31). This makes it possible to produce the TFTs 36 and 37 in one process. Furthermore, the liquid crystal display element 85 and the organic EL display element 86 share the TFT substrate 30, and display on the different surfaces facing back to back each other. This makes it simpler to arrange the display device 1.

Further, the display device 1 may be arranged such that the TFT (first switching element) 36 for driving the liquid crystal display element 85, the TFT (second switching element) 37 for driving the organic EL display element 86, and the light reflecting layer (pixel electrode 40) are provided on the identical glass substrate (second substrate) 31.

The following describes a schematically shown circuit of the display device 1 with reference to FIG. 2. FIG. 2 is a view schematically showing an equivalent circuit of the display device 1.

As shown in FIG. 2, the display device 1 is arranged such that the organic EL display elements 86 and the liquid crystal display elements 85 share a gate driver 101 and a source driver 100. Meanwhile, a scanning line G2 for scanning the TFT 36 for driving the liquid crystal element and a scanning line G1 for scanning the TFT 37 for driving the light-emitting display element are separately provided in the display device 1. Accordingly, the organic EL display elements 86 and the liquid crystal display elements 85 share the gate driver 101 and the source driver 100 in the display device 1, meanwhile the TFTs 36 and 37 are individually activated/not activated. Further, the source electrodes 35 of the TFTs 36 and 37 are connected to an identical data signal line S1.

In the liquid crystal display element 85 having the liquid crystal layer 20, a voltage greater than a threshold is applied to the TFT 36 via the scanning line G2 and the gate electrode 32, and the TFT 36 is activated in response to the voltage applied thereon. The TFT 36 thus activated controls a data signal to be supplied to the drain electrode 34 via the data signal line S1 and the source electrode 35. A voltage in accordance with the data signal is applied to the liquid crystal layer 20. Further, the voltage in accordance with the data signal is retained in a retention capacitor 372.

A TFT 370 for causing the organic EL material layer 52 to emit light, and a drive circuit 102 other than the TFT 37 are provided for the organic EL display element 86 including the organic EL material layer 52. A voltage greater than a threshold is applied to the TFT 37 via the scanning line G1 and the gate electrode 32, and the TFT 37 is activated in response to the voltage applied thereon. The TFT 37 thus activated controls a data signal to be supplied to the drain electrode 34 via the data signal line S1 and the source electrode 35. A voltage in accordance with the data signal is retained in a retention capacitor 371. In a case where the voltage retained in the retention capacitor 371 is greater than a threshold voltage of the TFT 370, a drive voltage (or a drive current) is applied to the organic EL material layer 52 from the drive circuit 102 through a signal line D1. That is, the TFT 37 connected to the scanning line is a switching TFT (Sw-TFT) for controlling the organic EL display element 86 to be driven/not driven. The TFT 370 is a TFT (Dr-TFT) for applying the drive current or the like to the organic EL display element 86 in accordance with an input signal supplied from the TFT 37.

As described above, the display device 1 is arranged such that it is possible to individually apply a voltage to the liquid crystal layer 20 and the organic EL material layer 52.

Further, it is also possible to provide a gate driver and a source driver only for the light-emitting display element, and similarly to provide another gate driver and source driver only for the liquid crystal display element in the display device 1. Meanwhile, the arrangement shown in FIG. 2 makes it possible to attain display due to liquid crystal and display due to an organic light-emitting material (organic EL material) with a simpler arrangement (without increase in the number of drivers).

### Second Embodiment

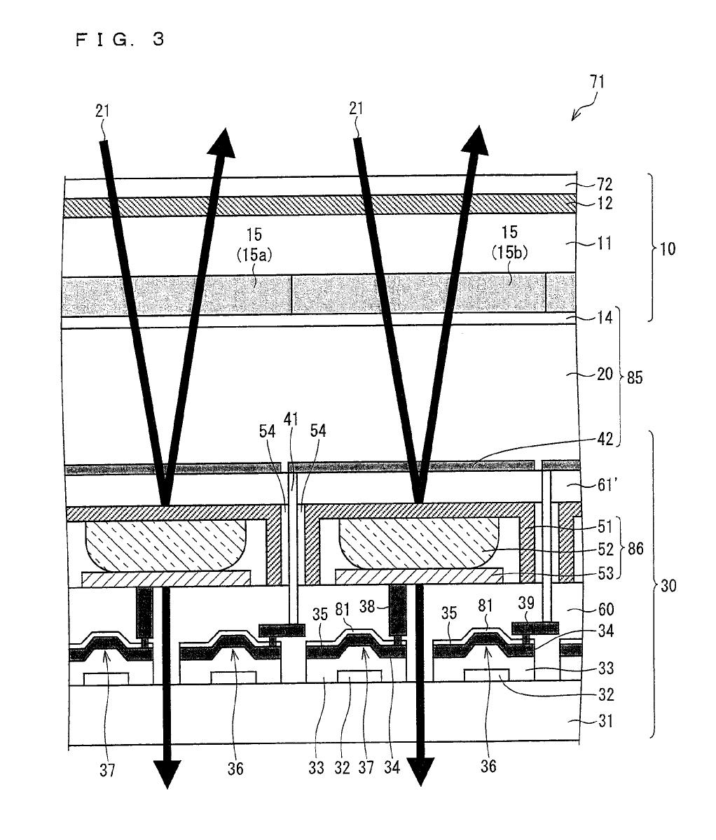

The following describes another embodiment of the display device of the present invention with reference to FIG. 3.

Note that, for the sake of easy explanation, like reference numerals herein refer to corresponding members having like functions in the drawings of First Embodiment, and descriptions of such members are omitted here.

FIG. 3 is a cross-sectional view schematically showing a display device 71 in accordance with the present embodiment. The display device 71 is different from the display device 1 (see FIG. 1) described in First Embodiment in that the display device 71 includes 1) an interlayer insulating film 61′ substituted for the interlayer insulating film 61, 2) pixel electrodes 42 substituted for the pixel electrodes 40, and 3) a diffuser (light-scattering means) 72 for scattering light.

The interlayer insulating film 61′ is an electrically insulating film made of a light-transmitting resin, and different from the interlayer insulating film 61 in that the interlayer insulating film 61′ has a flat surface that faces the glass substrate 11. Each of the pixel electrodes 42 is an electrode made of a light-transmitting electrode material such as ITO, and provided on the flat surface of the interlayer insulating film 61′. The diffuser 72 is provided, for example, on the polarizer 12.

The display device 71 and the display device 1 display identically to each other by use of the light-emitting display element. Meanwhile, the display devices 1 and 71 display differently from each other by use of the liquid crystal display element 85 as follows. The display device 71 is different from the display device 1 in that the reflective electrode (the second electrode 51) for causing light emitted from the organic EL material layer 52 to emit outside is also employed as a reflective plate for liquid crystal display. This difference is a very significant feature of the display device 71. Employing the reflective electrode as a reflective plate for liquid crystal display makes it possible to manufacture the display device 71 at lower cost and simpler, compared to manufacturing the display device 1. Further, the counter electrode 14 and the pixel electrode 42 for applying a voltage to the liquid crystal layer 20 can be manufactured with a homogeneous or identical transparent electrode material. This allows the display device 71 to have a more preferable and reliable liquid crystal display property, compared to a case where the counter electrode and the pixel electrode are made of different electrode materials (for example, one of the counter electrode and the pixel electrode is made of a light-transmitting electrode material, and the other is made of a light reflective electrode material). Specifically, the display device 71 is arranged as follows. The external light 21 that enters the display device 1 from the outside of the glass substrate 11 (the polarizer 12) is successively transmitted through the diffuser 72, the polarizer 12, the glass substrate 11, the color filter 15, the counter electrode 14, the liquid crystal layer 20, the pixel electrode 42 and the interlayer insulating film 61′, and then reflected on the flat surface of the second electrode 51. Thereafter, the reflected external light 21 is successively transmitted through the interlayer insulating film 61′, the pixel electrode 42, the liquid crystal layer 20 driven in accordance with the data signal, the counter electrode 14, the color filter 15, the glass substrate 11, the polarizer 12 and the diffuser 72, and then emitted outside from the glass substrate 11.

More specifically, the reflected external light 21 is scattered by the diffuser 72 when the reflected external light 21 passes through the diffuser 72. Such scattered light is emitted outside from the glass substrate 11. Therefore, even in a case where a user views the display device 71 from a side where the glass substrate 11 is provided in the display device 71, the user does not recognize the second electrode 51 or the like. It is accordingly possible to retain an excellent display property.

The diffuser 72 can be provided between the second electrode 51 that serves as a light reflecting layer and a user. In other words, the diffuser 72 can be provided in any place in the path of the external light reflected on the second electrode 51 serving as a light reflecting layer. Specifically, the diffuser 72 can be provided between the polarizer 12 and the liquid crystal layer 20. More specifically, the diffuser 72 can be provided between the polarizer 12 and the glass substrate 11. Meanwhile, it is preferable to provide the diffuser 72 between the polarizer 12 and a user as shown in FIG. 3, so as not to disturb a state of light polarized by the polarizer 12. Further, in a case where the polarizer 12 is provided on an outermost surface of the display device 71, and the diffuser is provided closer to the liquid crystal layer than the polarizer 12, a surface treatment carried out on the polarizer 12 is possibly less damaged.

As an alternate, the display device 71 can be arranged such that the second electrode 51 has an uneven surface by which the external light that enters the display device 71 is (diffusedly reflected) scattered. Such an arrangement makes it unnecessary to provide the diffuser 72 in the display device 71. That is, providing the diffuser 72 in the display device 71 is applied to particularly a case where the light reflecting layer has a flat surface that reflects light (namely, a case where light is substantially specularly reflected).

Further, a circuit for driving the display device 71 may be arranged in the same manner as the circuit (see FIG. 2) of the display device 1 of First Embodiment. Therefore, the circuit of the display device 71 is not described in detail in the present embodiment.

Further, the display device 71 of the present embodiment includes the organic EL material layer as a light-emitting layer. As an alternate, the display device 71 may include, as the light-emitting layer, a material layer such as an inorganic light-emitting material layer, a light-emitting layer made of a carbon nanotube, a field emission type light-emitting layer, or a light-emitting layer made of OLED (Organic Light Emitting Diode) chip that is applicable to a self-luminous display element.

Further, the display device 71 of the present embodiment includes the diffuser 72 for scattering light. Meanwhile, the external light reflected on the light reflecting layer can be scattered as appropriate by another means so as to be supplied to a user.

### Third Embodiment

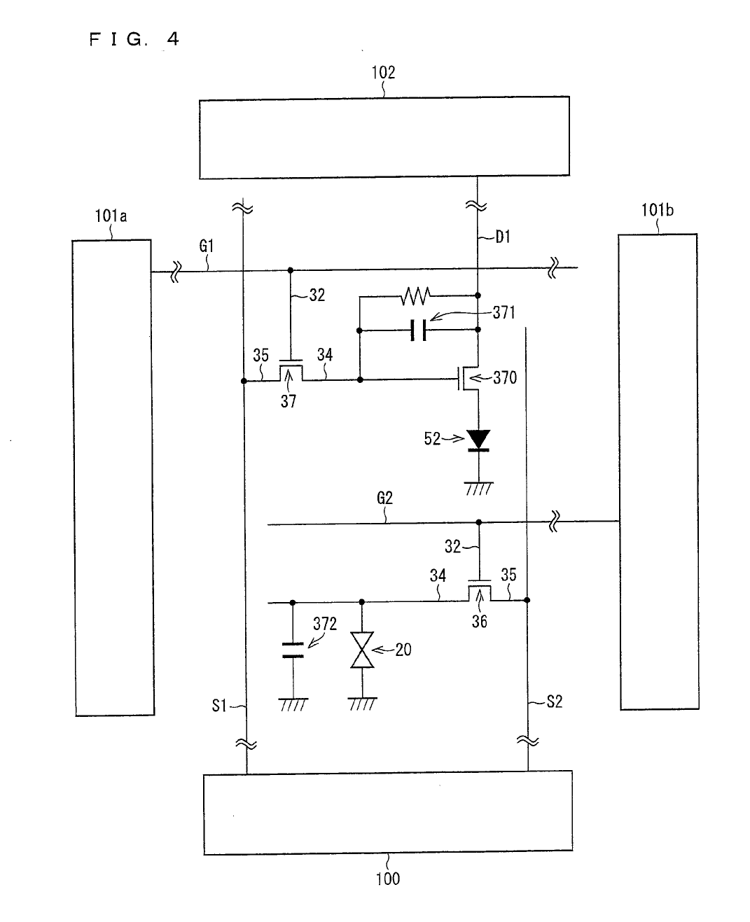

The following describes yet another embodiment of the display device of the present invention with reference to FIG. 4.

Note that, for the sake of easy explanation, like reference numerals herein refer to corresponding members having like functions in the drawings of First and Second Embodiments, and descriptions of such members are omitted here.

FIG. 4 is a circuit view schematically showing another equivalent circuit of the display device 1 or the display device 71 (see FIGS. 1 and 3).

The equivalent circuit shown in FIG. 4 is mainly different from the equivalent circuit shown in FIG. 2 in that the equivalent circuit shown in FIG. 4 includes a gate driver 101a for driving the organic EL display elements 86 each including the organic EL material layer 52 and a gate driver 101b for driving the liquid crystal display elements 85 each including the liquid crystal layer 20. Specifically, the gate drivers 101a and 101b made of p-Si are provided in a left-hand side and a right-hand side of the display device 1 or the display device 71. This arrangement makes it possible to merely output in order voltages for opening gates to a plurality of scanning lines for scanning the gates so that the gates are scanned. It is therefore possible to simplify how the gate driver is arranged.

The equivalent circuit shown in FIG. 4 is identical to the equivalent circuit shown in FIG. 2 in that the drive circuit 102 and the source driver 100 are provided in upper and lower sides of the display device 1 or the display device 71. However, the equivalent circuit shown in FIG. 4 is different from the equivalent circuit shown in FIG. 2 in that the equivalent circuit shown in FIG. 4 is arranged such that the data signal line S1 supplies a data signal to the TFT 37 only and a data signal line S2 supplies a data signal to the TFT 36 only. Such an arrangement makes it possible to simultaneously supply different data signals to the organic EL display elements 86 and the liquid crystal display elements 85. This enables, for example, simultaneously displaying different images or the like on the glass substrate 11 (closer to the liquid crystal display elements) and the glass substrate 31 (closer to the light-emitting display elements).

As described above, a display device of the present invention includes: a first substrate; a second substrate facing the first substrate; a light reflecting layer provided between the first substrate and the second substrate; a reflective liquid crystal display element including a liquid crystal layer provided between the first substrate and the light reflecting layer; a light-emitting display element including a light-emitting layer provided between the second substrate and the light reflecting layer; a first switching element for controlling driving of the liquid crystal display element; and a second switching element for controlling driving of the light-emitting display element.

Further, it is preferable to arrange the display device of the present invention such that the light reflecting layer serves as an electrode for applying a voltage to the light-emitting layer.

According to the above arrangement, the electrode for applying the voltage to the light-emitting layer also serves as the light reflecting layer employed for liquid crystal display. This makes it possible to produce a display device at lower cost and simpler, compared to a display device including an individual light reflecting layer.

It is preferable that the display device of the present invention includes light scattering means for scattering light reflected on the light reflecting layer, the light scattering means being provided on a path through which the reflected light passes.

According to the above arrangement, the light reflected on the light reflecting layer is scattered by the light-scattering means. Such scattered light reaches a user. It is therefore possible to provide excellent liquid crystal display to the user.

It is preferable to arrange the display device of the present invention such that both the first switching element and the second switching element are provided on the second substrate.

According to the above arrangement, the first switching element and the second switching element can be formed together on the second substrate. This makes it possible to provide a display device that is simply arranged and easily produced.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to a display device that carries out liquid crystal display and light-emitting display.

### REFERENCE SIGNS LIST

1: display device

11: glass substrate (first substrate)

20: liquid crystal layer

21: external light (light)

31: glass substrate (second substrate)

36: TFT (first switching element)

37: TFT (second switching element)

40: pixel electrode (light reflecting layer)

51: second electrode (light reflecting layer; electrode)

52: organic EL material layer (light-emitting layer)

71: display device

72: diffuser (light scattering means)

85: liquid crystal display element

86: organic EL display element (light-emitting display element)

1. A display device comprising:
a first substrate;
a second substrate facing the first substrate;
a light reflecting layer provided between the first substrate and the second substrate;
a reflective liquid crystal display element for performing display operation by employing light reflected on the light reflecting layer, the reflective liquid crystal display element including a liquid crystal layer provided between the first substrate and the light reflecting layer;
a light-emitting display element for performing display operation by employing light emitted from a light-emitting layer included in the light-emitting display element, the light-emitting layer being provided between the second substrate and the light reflecting layer;
a first switching element for controlling driving of the liquid crystal display element, the first switching element being provided between the first substrate and the second substrate; and
a second switching element for controlling driving of the light-emitting display element, the second switching element being provided between the first substrate and the second substrate.

2. The display device as set forth in claim 1 wherein the light-emitting layer emits light in response to a voltage applied thereon, and the light reflecting layer serves as an electrode for applying the voltage to the light-emitting layer.

3. The display device as set forth in claim 1 comprising light scattering means for scattering light reflected on the light reflecting layer, the light scattering means being provided on a path through which the reflected light passes.

4. The display device as set forth in claim 1 wherein both the first switching element and the second switching element are provided on the second substrate.

5. The display device as set forth in claim 1 wherein the light reflecting layer has an uneven surface that reflects light.

6. The display device as set forth in claim 1 further comprising a scanning line for scanning the first switching element and a scanning line for scanning the second switching element.

7. The display device as set forth in claim 6 further comprising a gate driver for the scanning line for scanning the first switching element, and a gate driver for the scanning line for scanning the second switching element.
